(19) United States
(12) Patent Application Publication
(10) Pub. No.: US 2006/0172263 A1
(43) Pub. Date: Aug. 3, 2006

(54) MILL BLANK

(75) Inventors: Henley S. Quadling, Addison, TX (US); Mark S. Quadling, Plano, TX (US); Robert G. Caflisch, Flower Mound, TX (US)

Correspondence Address: LAW OFFICE OF DAVID H. JUDSON, 15950 DALLAS PARKWAY, SUITE 225, DALLAS, TX, 75248, US

(73) Assignee: D4D TECHNOLOGIES, LP, Richardson, TX (US)

(21) Appl. No.: 10/906,062

(22) Filed: Feb. 1, 2005

(51) Int. Cl. A61C 1/00; B29B 7/00

(52) U.S. Cl. 433/229; 428/542.8

(57) ABSTRACT

The present invention relates generally to mill blank constructions. According to the invention, a “smart blank” is pre-configured into a form that closely resembles a restoration being designed. The blank comprises a body adapted to be shaped by material removal into an artificial tooth part having buccal-lingual, mesial-distal and occlusal-cervical axes. In an illustrative embodiment, the body has at most one symmetric plane that is defined by a buccal-lingual-occlusal-cervical cross-section whose normal is along the mesial-distal axis. The blank also includes a holder for mounting the blank in a shaping apparatus. The smart blank provides more efficient milling and high yield.

### BACKGROUND OF THE INVENTION

The present invention relates generally to mill blank constructions for use in preparing dental restorations.

The art of fabricating custom-fit prosthetics in the dental field is well-known. Prosthetics are replacements for tooth or bone structure. They include restorations, replacements, inlays, onlays, veneers, full and partial crowns, bridges, implants, posts, and the like. Typically, a dentist prepares a tooth for the restoration by removing existing anatomy, which is then lost. The resultant preparation may be digitized or a dental impression is taken, for the purpose of constructing a restoration. The restoration may be constructed through a variety of techniques including manually constructing the restoration, using automated techniques based on computer algorithms, or a combination of manual and automated techniques. In one known technique, the prosthetic is fabricated using a computer-assisted (CAD/CAM) system, such as a computer-aided milling machine. One such machine is the CEREC 3D system from Sirona Dental Systems. Computer-aided machines of this type work by shaping the prosthetic from mill blanks. A mill blank is a solid block of material from which the prosthetic is shaped by a shaping apparatus whose movements are controlled by the computer. Under computer control, the size, shape, and arrangement of the restoration may be varied to match the neighboring teeth.

A typical mill blank includes a sufficiently large rigid attachment so that it may be held solidly while the machining process is underway. A rectangular or cylindrical blank is commonly used, and the vast majority of material is removed via the machining process. U.S. Pat. No. 4,615,678 to Moermann et al. discloses a conventional mill blank of this type made of ceramic silica material. The above-identified patent also describes that the body portion of a mill blank can be formed in a way to minimize wear on and run time of the milling machine, namely, by being shaped initially to more closely resemble the final implant. An example illustrated in the patent is a blank for use in forming a two lobed inlay that includes a transverse groove in one side thereof. U.S. Published Patent Application 2003/0031984 to Rusin et al. illustrates a similar blank construction, and this application further notes that blanks can come in a variety of shapes and sizes.

While such prior art constructions are useful, there remains a need in the art to provide mill blank configurations that facilitate milling operations in a manner to reduce material waste, and to reduce machining time.

### BRIEF SUMMARY OF THE INVENTION

It is an object of the present invention to provide a mill blank that has been pre-configured to a target size, shape and configuration. Preferably, the blank comprises a body adapted to be shaped by material removal into an artificial tooth part having buccal-lingual, mesial-distal and occlusal-cervical axes. In an illustrative embodiment, the body is without meaningful symmetry with respect to any such axis of orientation. In a preferred embodiment, the body has at most one symmetric plane that is defined by a buccal-lingual-occlusal-cervical cross-section whose normal is along the mesial-distal axis. The blank also includes a holder for mounting the blank in a shaping apparatus.

According to another embodiment, a mill blank comprises a body adapted to be shaped by material removal into an artificial tooth part, and a holder attached to the body. The body may be formed of precious or semi-precious metal or metal alloy, or of ceramic and, preferably, the body is defined by buccal-lingual, mesial-distal and occlusal-cervical axes. In this embodiment, the body has a shape defined by selectable values of a set of geometric parameters, e.g., one or more of the following: diameter, flat length, height, width, shift, apex height and center thickness.

Thus, for example, the diameter parameters may be selected from the group consisting of: a mesial-distal diameter (MMD), a buccal-lingual diameter (MBD), an occlusal mesial-distal diameter (OMD), an occlusal buccal-lingual diameter (OBD), a cervical buccal-lingual inner diameter (CBD), and a cervical mesial-distal inner diameter (CMD). The flat length parameters may be selected from the group consisting of: a mesial-distal flat length (MMF), a buccal-lingual flat length (MBF), an occlusal buccal-lingual flat length (OBF), an occlusal mesial-distal flat length (OMF), a cervical buccal-lingual flat length (CBF), a cervical mesial-distal flat length (CMF), and a cervical-occlusal flat length (CF). The height parameters may be selected from the group consisting of: a cervical-occlusal buccal height (CBH), a cervical-occlusal lingual height (CLH), a cervical-occlusal mid-buccal-lingual height (CMH), and a cervical-occlusal cusp height (CCH). The width parameters may be selected from the group consisting of: an occlusal notch width (NW), and a cervical margin width (CMW). The miscellaneous parameters may be selected from the group consisting of: an occlusal notch buccal shift (BS), an occlusal notch depth (ND), a center apex height (CA), and a center thickness (CT).

A representative blank of this form may be manufactured using computer-assisted design techniques. Thus, according to another feature of the invention, a computer-implemented method of making a blank having buccal-lingual, mesial-distal and occlusal-cervical axes comprises: assigning values to one or more of a set of geometric parameters that together define the shape of the mill blank body, and; forming a blank in accordance with the assigned values. The geometric parameters preferably are selected from the group consisting of: a mesial-distal diameter (MMD), a mesial-distal flat length (MMF), a buccal-lingual diameter (MBD), a buccal-lingual flat length (MBF), an occlusal mesial-distal diameter (OMD), an occlusal mesial-distal flat length (OMF), an occlusal buccal-lingual diameter (OBD), an occlusal buccal-lingual flat length (OBF); an occlusal notch width (NW), an occlusal notch depth (ND), an occlusal notch buccal shift (BS), a cervical buccal-lingual inner diameter (CBD), a cervical buccal-lingual flat length (CBF), a cervical mesial-distal inner diameter (CMD), a cervical mesial-distal flat length (CMF), a cervical margin width (CMW), a cervical-occlusal buccal height (CBH), a cervical-occlusal lingual height (CLH), a cervical-occlusal mid-buccal-lingual height (CMH), a cervical-occlusal cusp height (CCH), a cervical-occlusal flat length (CF), a center apex height (CA), and a center thickness (CT). The above-identified geometric parameters are exemplary, and it is not required that a particular mill blank construction according to the invention include each such attribute.

A mill blank having a body with at most one symmetric plane with respect to its buccal-lingual, mesial-distal and occlusal-cervical axes provides significant advantages over the prior art. The blank includes significantly less material than a conventional rectangular or otherwise symmetric blank, thereby producing a high yield when in use in a milling machine.

Other features and advantages of the invention will be apparent to one with skill in the art upon examination of the following figures and detailed description. It is intended that all such additional features and advantages be included within this description, be within the scope of the invention, and be protected by the claims.

### BRIEF DESCRIPTION OF THE DRAWINGS

The invention may be better understood with reference to the following drawings and its accompanying description. Unless otherwise stated, the components in the figures are not necessarily to scale, emphasis instead being placed upon illustrating the principles of the invention. Moreover, in the figures, like referenced numerals designate corresponding parts throughout the different views.

FIG. 1 illustrates a perspective view of a smart blank body according to an embodiment of the present invention, intersecting a plane of symmetry having a buccal-lingual-occlusal-cervical orientation;

FIG. 2 is another perspective view of the smart blank body and symmetry plane of FIG. 1 slightly rotated to better illustrate the cervical aspect;

FIG. 3 illustrates given design parameters on the buccal or lingual aspect of the smart blank body of FIG. 1;

FIG. 4 illustrates given design parameters on the occlusal aspect of the smart blank body of FIG. 1;

FIG. 5 illustrates given design parameters on the mesial or distal aspect of the smart blank body of FIG. 1;

FIG. 6 illustrates given design parameters on the cervical aspect of the smart blank body of FIG. 1;

FIG. 7 illustrates a buccal-lingual-occlusal-cervical cross-section of the smart blank body of FIG. 1 showing the dimensions of the cervical concavity in the illustrated embodiment;

FIG. 8 illustrates an attainable shape different from the smart blank body of FIG. 1;

FIG. 9 illustrates a computer system for use in facilitating a computer-assisted design process of the smart blank body of FIG. 1;

FIG. 10 illustrates an illustrative display menu by which an operator of the computer of FIG. 9 may input values for the design parameters; and

FIG. 11 illustrates a smart blank that has a holder attached to the smart blank body of FIG. 1 to facilitate shaping of the smart blank in a shaping apparatus.

### DETAILED DESCRIPTION OF THE PREFERRED EMBODIMENTS

For illustrative purposes, the following terms may be afforded the following meanings in the context of the present invention:

A “blank” is a part adapted for use in custom fabrication of a dental restoration, such as a full contour crown. Typically, a blank comprises a body for being shaped by material removal, and a holder (a “sprue” or mandrel) for mounting the blank in a shaping apparatus such as a CAD/CAM (or other) milling machine, device or system. The body may be attached to the holder in any convenient manner, such as by a mechanical interface, by welding, by an adhesive, or the like. A “smart blank” is a blank that has been pre-configured into a form that closely resembles a restoration under construction. The “yield” of a smart blank is the amount of material of the body part that ends up being useful for the restoration during the milling of the blank.

The mill blank body may be formed of any suitable blank material including, without limitation, a precious metal or metal alloy, a semi-precious metal or metal alloy, a ceramic or other inorganic non-metallic material, combinations thereof, or the like. The body is adapted to be formed or milled into any type of restoration (or other dental prosthetic) by hand or by a milling machine, such as a machine that uses a CAD/CAM system. Any convenient cutting technique can be used for this purpose.

It is known in the art that a given tooth or tooth part may be defined by certain anatomical reference points relative to the human mouth. Thus, typically, a given tooth or tooth part may be considered to have certain “aspects” corresponding to the buccal-lingual, mesial-distal and occlusal-cervical axes relative to the patient's mouth. A detailed description of such orientations is provided, for example, in such standard treatises as Wheeler's Dental Anatomy, Physiology, and Occlusion, W. B. Saunders Company, chap. 1 (pages 1-27), which is incorporated herein by reference. For ease of illustration, the present invention is described in the context of such anatomical references.

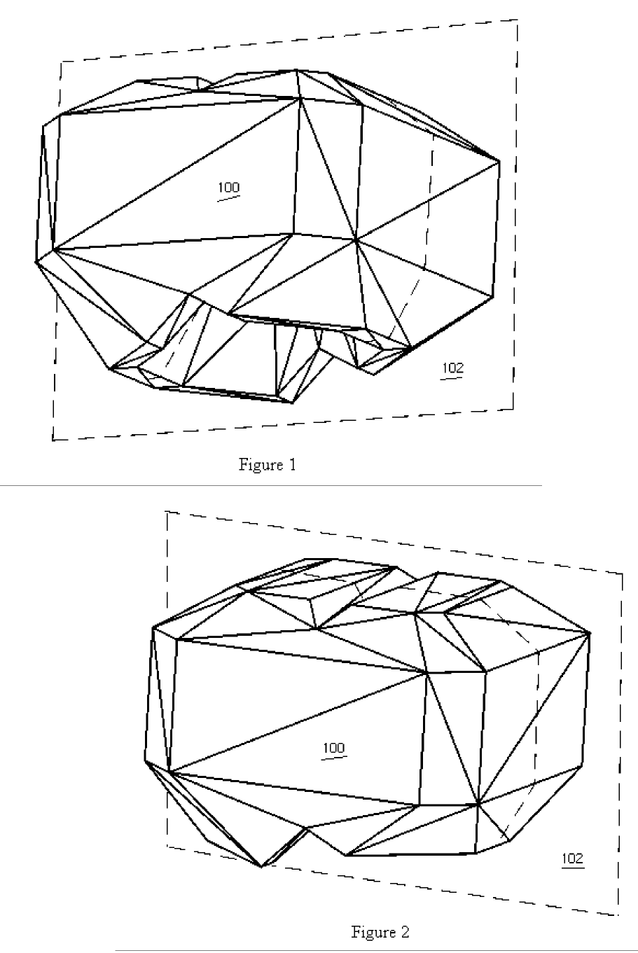

According to the invention, a smart blank body 100 such as illustrated in FIG. 1 has a substantially asymmetric construction yet closely resembles a tooth part, such as a full contour crown. As illustrated, the body preferably has numerous facets (or chamfers) that are created during the design process, which will be described in detail below. By creating the smart blank body in this manner and with this highly asymmetric construction, the actual milling process is simple (and faster) as compared to the prior art because the mill blank shape (initially) is actually very close to the final milled product; as a consequence, the yield during the milling process is quite high. High yields are especially important when the blank is formed of an expensive material, such as gold. Thus, according to the present invention, a multi-faceted smart blank body construction is provided that facilitates the milling process and substantially increases yield.

FIG. 2 illustrates the smart blank body of FIG. 1 rotated slightly downward to provide further detail of the blank's occlusal aspect. As illustrated in FIGS. 1 and 2, and as described above, preferably the smart blank body 100 is highly asymmetric. In a preferred embodiment, the smart blank body 100 has just one symmetric plane, which is the plane 102 (as illustrated in both FIG. 1 and FIG. 2). In the context of standard anatomical reference points, plane 102 may be defined as the buccal-lingual-occlusal-cervical plane. As is readily apparent to one of ordinary skill, the buccal-lingual-occlusal-cervical cross-section has a normal along the mesial-distal axis. Symmetry about this plane is preferred, but it is not necessarily required. Indeed, the smart blank body of the present invention need not be symmetric about any plane. Thus, smart blank body constructions that have zero or, at most, one symmetric plane, are considered to be within the scope of the present invention.

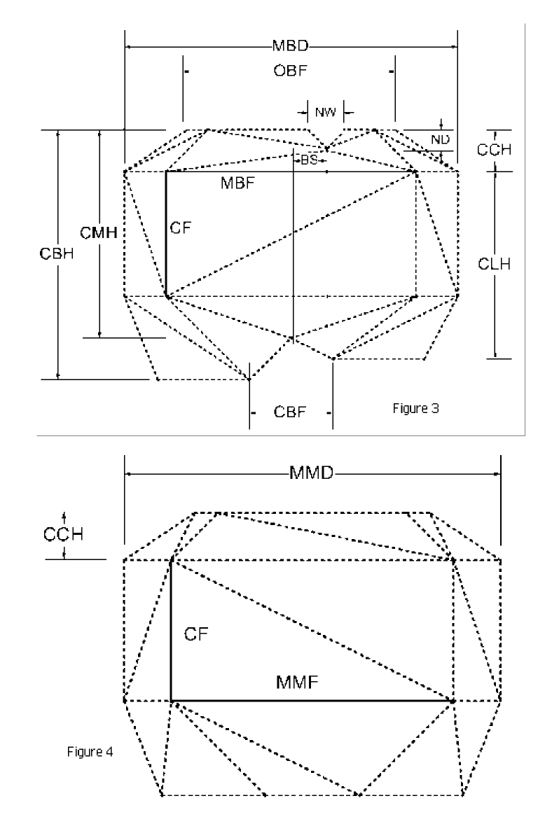

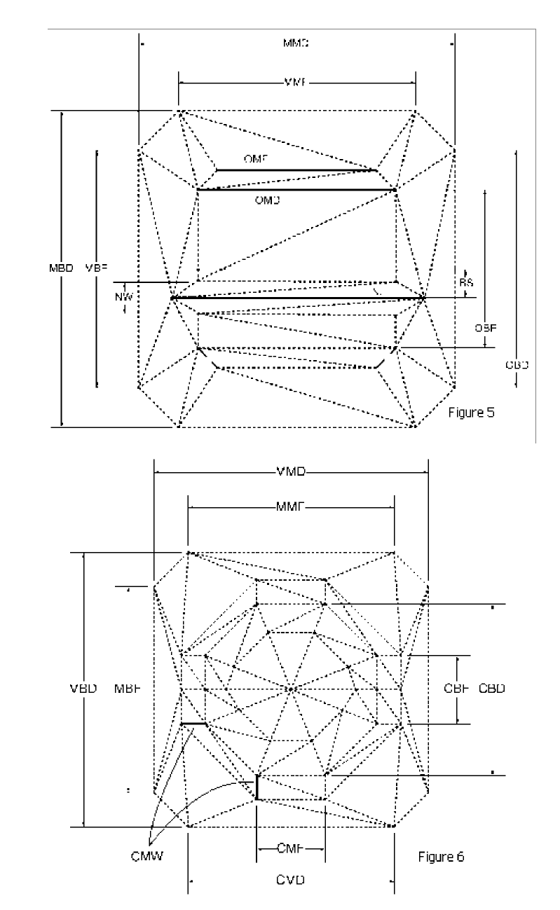

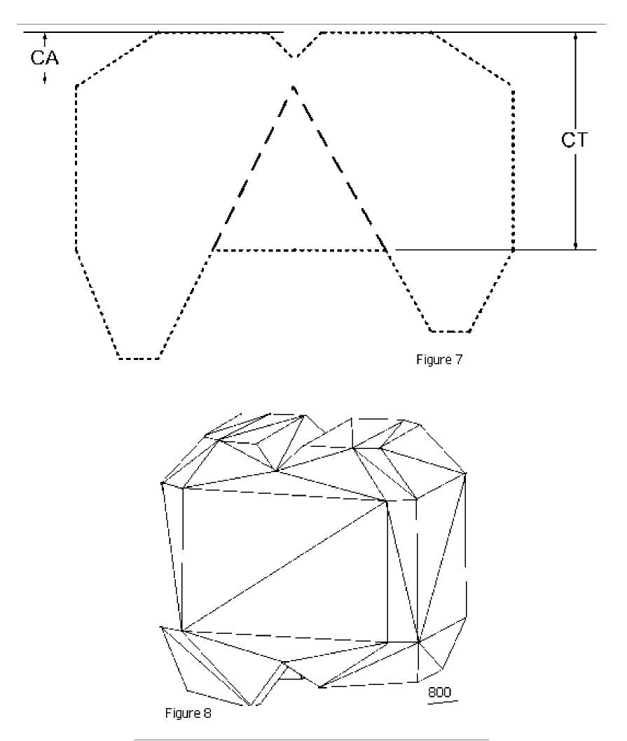

In the illustrative embodiment of FIGS. 1 and 2, the smart blank body is defined by a plurality of geometric parameters that, together, define the multi-faceted construction. It is not required that a particular smart blank body have all of these facets; indeed, the advantages of the present invention (faster milling, higher yield) can be achieved with any smart blank body that has zero or at most one symmetric plane, whether the multi-faceted design is implemented. Although less desirable than the configuration in FIG. 1, some symmetry may also be tolerated, although one of ordinary skill will appreciate that, as the blank becomes more symmetric, the yield may be reduced. In the illustrated embodiment, the smart blank body has a shape defined by selectable values of a set of geometric parameters that can be generally classified as follows: diameter, flat length, height, width, shift, apex height and center thickness. FIG. 3 illustrates the given design parameters exposed on the buccal or lingual aspect of the smart blank body of FIG. 1. FIG. 4 illustrates the given design parameters exposed on the occlusal aspect of the smart blank body of FIG. 1. FIG. 5 illustrates the given design parameters exposed on the mesial or distal aspect of the smart blank body of FIG. 1. FIG. 6 illustrates the given design parameters exposed on the cervical aspect of the smart blank body of FIG. 1.

These geometric parameters preferably are defined as follows:

| Variable | Abbreviation |
|---|---|
| CornerMD | — |
| ornerBL | — |
| CornerOC | — |
| MidMDDiameter | MMD |
| MidMDFlatLength | MMF |
| MidBLDiameter | MBD |
| MidBLFlatLength | MBF |
| OclMDDiameter | OMD |
| OclMDFlatLength | OMF |
| OclBLDiameter | OBD |
| OclBLFlatLength | OBF |
| MDOclNotchWidth | NW |
| MDOclNotchDepth | ND |
| MDOclNotchBucShift | BS |
| CrvcBLInnerDiameter | CBD |
| CrvcBLFlatLength | CBF |
| CrvcMDInnerDiameter | CMD |
| CrvcMDFlatLength | CMF |
| CervicalMarginWidth | CMW |
| COBuccalHeight | CBH |
| COLingualHeight | CLH |
| COMidBLHeight | CMH |
| COCuspHeight | CCH |
| COFlatLength | CF |
| CenterThickness | CT |
| CenterApexHeight | CA |
| NotchLength* | NL |

The values CornerMD, CornerBL and CornerOC are the coordinates of the occlusal-mesial-buccal corner for display purposes; typically, these values have no impact on the shape of the tooth blank. The CenterApexHeight is the position of an imaginary point that is not itself part of the structure, but this value may be used to control the steepness of the walls in the concavity of the cervical aspect (as viewed in FIG. 6). In this regard, FIG. 7 illustrates a buccal-lingual-occlusal-cervical cross-section of the smart blank body of FIG. 1 showing the dimensions of the cervical concavity. Typically, the NotchLength parameter is not independently controllable but results from the interaction of various other selections.

One of ordinary skill in the art will appreciate that different smart blank body shapes are generated by varying one or more the geometric parameters. FIG. 8 illustrates one attainable body shape 800 that is different from the smart blank body of FIG. 1. There is no restriction of the nature and type of body shapes that can be generated using the above-described techniques. Moreover, by modifying the above parameters or adding others, the techniques of the present invention may also be used to design and manufacture other dental restorations, such as copings.

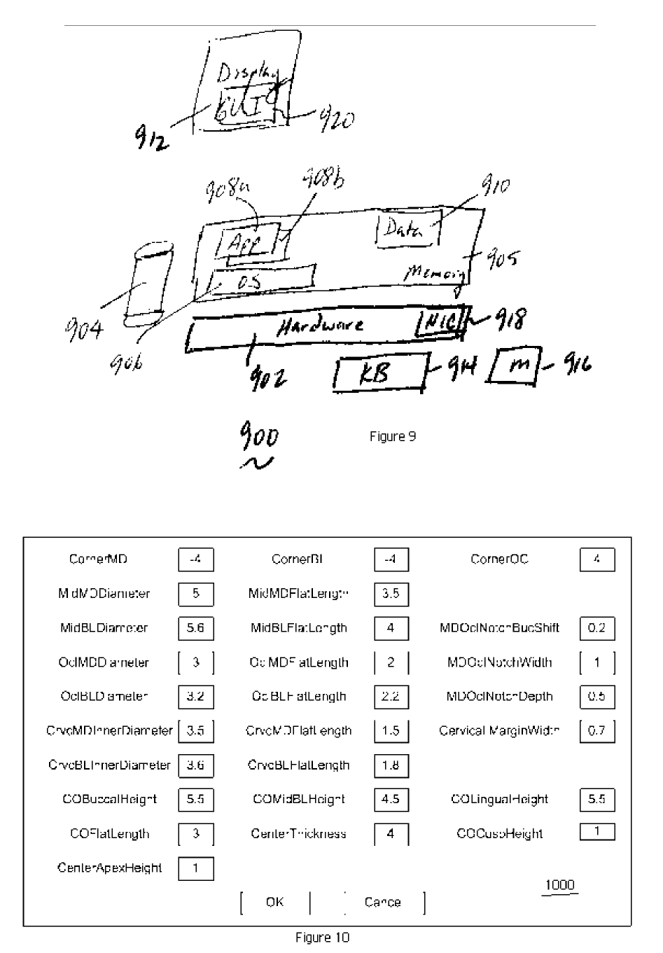

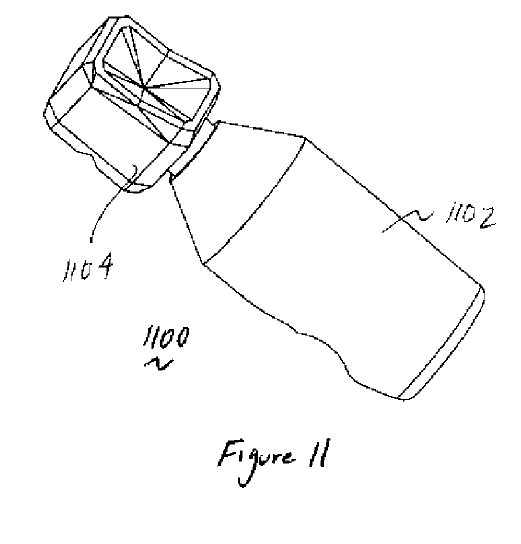

A computer or computer system may be used to design the smart blank body using the set (or any given subset of) the above-described geometric parameters. A representative computer system is illustrated in FIG. 9. The computer 900 comprises Intel-commodity hardware 902, suitable storage 904 and memory 905 for storing an operating system 906 (such as Linux, W2K, or the like), software applications 908a-n and data 910, conventional input and output devices (a display 912, a keyboard 914, a mouse 916, and the like), devices 918 to provide network connectivity, and the like. Using a conventional graphical user interface 920, an operator can enter design values for one or more given geometric parameters. FIG. 10 illustrates a representative display menu 1000 into which the operator enters given design values for the diameter, flat length, height, width, shift, apex height and center thickness parameters. The values indicated in the various display fields are merely representative. Preferably, the computer includes software executed by the hardware for translating the parameter inputs into a 2-D visual representation of the smart blank body. FIGS. 3-6 illustrate such a representation. One of ordinary skill will appreciate that the design of the smart blank body can be altered readily by having the operator modify the particular values that are input in the menu. Alternatively, the system can provide default values for a given smart blank, and a library of such blanks can be maintained as needed.

In use, a given geometry of the designed restoration is made available to the computer system. The system has knowledge of the unique geometries of each of the smart blanks then available from the library. Using a given criterion (which the operator can select or that may be a default), the system then selects the smart blank from the available blanks that satisfies the given criterion, or that satisfies the given criterion within a given acceptance factor.

Thus, according to a feature of the invention, the smart blank design and visualization process is automated, i.e., under the control of a suitably programmed processor or other controller. While certain aspects or features of the present invention have been described in the context of a computer-based method or process, this is not a limitation of the invention. Moreover, such computer-based methods may be implemented in an apparatus or system for performing the described operations, or as an adjunct to other dental milling equipment, devices or systems. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including optical disks, CD-ROMs, and magnetic-optical disks, read-only memories (ROMs), random access memories (RAMs), magnetic or optical cards, or any type of media suitable for storing electronic instructions, and each coupled to a computer system bus. The computer may be connected to any wired or wireless network. Further, the above-described functions and features may be implemented within or as an adjunct to other known dental milling equipment, devices or systems.

FIG. 11 illustrates a smart blank 1100 that has a holder 1102 attached to the smart blank body 1104 of FIG. 1 to facilitate shaping of the smart blank in a shaping apparatus.

What is claimed is:

1. A blank, comprising:
a body adapted to be shaped by material removal into an artificial tooth part having buccal-lingual, mesial-distal and occlusal-cervical axes, the body having at most one symmetric plane that is defined by a buccal-lingual-occlusal-cervical cross-section whose normal is along the mesial-distal axis.

2. The blank as described in claim 1 further including a holder for mounting the blank in a shaping apparatus.

3. The blank as described in claim 1 wherein the body is formed of a material selected from: a precious metal, a precious metal alloy, a semi-precious metal, a semi-precious metal alloy, and a ceramic.

4. A blank, comprising:
a body adapted to be shaped by material removal into an artificial tooth part having buccal-lingual, mesial-distal and occlusal-cervical axes, wherein the body has a shape defined by selectable values of each of a set of geometric parameters selected from the group consisting of: mesial-distal diameter (MMD), mesial-distal flat length (MMF), buccal-lingual diameter (MBD), buccal-lingual flat length (MBF), occlusal mesial-distal diameter (OMD), occlusal mesial-distal flat length (OMF), occlusal buccal-lingual diameter (OBD), occlusal buccal-lingual flat length (OBF); occlusal notch width (NW), occlusal notch depth (ND), occlusal notch buccal shift (BS), cervical buccal-lingual inner diameter (CBD), cervical buccal-lingual flat length (CBF), cervical mesial-distal inner diameter (CMD), cervical mesial-distal flat length (CMF), cervical margin width (CMW), cervical-occlusal buccal height (CBH), cervical-occlusal lingual height (CLH), cervical-occlusal mid-buccal-lingual height (CMH), cervical-occlusal cusp height (CCH), cervical-occlusal flat length (CF), a center apex height (CA), and a center thickness (CT).

5. The blank as described in claim 4 wherein the body has at most one symmetric plane that is defined by a buccal-lingual-occlusal-cervical cross-section whose normal is along a mesial-distal axis.

6. The blank as described in claim 4 wherein the body is formed of a material selected from: a precious metal, a precious metal alloy, a semi-precious metal, a semi-precious metal alloy, and a ceramic.

7. A blank, comprising:
a body adapted to be shaped by material removal into an artificial tooth part having buccal-lingual, mesial-distal and occlusal-cervical axes, the body having at most one symmetric plane along a given plane, the given plane being defined by a plane whose normal is along the mesial-distal axis; and
a holder for mounting the blank in a shaping apparatus.

8. A computer-implemented method of making a blank having buccal-lingual, mesial-distal and occlusal-cervical axes, comprising:
assigning values of each of a set of geometric parameters selected from the group consisting of: mesial-distal diameter (MMD), mesial-distal flat length (MMF), buccal-lingual diameter (MBD), buccal-lingual flat length (MBF), occlusal mesial-distal diameter (OMD), occlusal mesial-distal flat length (OMF), occlusal buccal-lingual diameter (OBD), occlusal buccal-lingual flat length (OBF), occlusal notch width (NW), occlusal notch depth (ND), occlusal notch buccal shift (BS), cervical buccal-lingual inner diameter (CBD), cervical buccal-lingual flat length (CBF), cervical mesial-distal inner diameter (CMD), cervical mesial-distal flat length (CMF), cervical margin width (CMW), cervical-occlusal buccal height (CBH), cervical-occlusal lingual height (CLH), cervical-occlusal mid-buccal-lingual height (CMH), cervical-occlusal cusp height (CCH), cervical-occlusal flat length (CF), a center apex height (CA), and a center thickness (CT); and
forming the blank in accordance with the assigned values.

9. The computer-implemented method of making as described in claim 8 further including the step of displaying a representation of the blank as defined by the set of geometric parameters.

10. The computer-implemented method of making as described in claim 8 further including the step of modifying at least one assigned value to alter a configuration of the blank.

11. A blank, comprising:
a body adapted to be shaped by material removal into an artificial tooth part having buccal-lingual, mesial-distal and occlusal-cervical axes, wherein the body has a shape defined by selectable values of a set of diameter, flat length, height, width, shift and center thickness geometric parameters; and
a holder attached to the body.

12. The blank as described in claim 11 wherein the diameter parameters are selected from the group consisting of: mesial-distal diameter (MMD), buccal-lingual diameter (MBD), occlusal mesial-distal diameter (OMD), occlusal buccal-lingual diameter (OBD), cervical buccal-lingual inner diameter (CBD) and cervical mesial-distal inner diameter (CMD).

13. The blank as described in claim 11 wherein the flat length parameters are selected from the group consisting of: a mesial-distal flat length (MMF), a buccal-lingual flat length (MBF), an occlusal mesial-distal flat length (OMF), an occlusal buccal-lingual flat length (OBF), a cervical buccal-lingual flat length (CBF), a cervical mesial-distal flat length (CMF), and a cervical-occlusal flat length (CF).

14. The blank as described in claim 11 wherein the height parameters are selected from the group consisting of: a cervical-occlusal buccal height (CBH), a cervical-occlusal lingual height (CLH), a cervical-occlusal mid-buccal-lingual height (CMH), and a cervical-occlusal cusp height (CCH).

15. The blank as described in claim 11 wherein the width parameters are selected from the group consisting of: an occlusal notch width (NW), and a cervical margin width (CMW).

16. The blank as described in claim 11 wherein the geometric parameters are selected from the group consisting of: an occlusal notch buccal shift (BS), an occlusal notch depth (ND), a center apex height (CA), and a center thickness (CT).
